(19) United States
(12) Patent Application Publication
(10) Pub. No.: US 2022/0183022 A1
(43) Pub. Date: Jun. 9, 2022

(54) METHOD OF PHYSICAL UPLINK CONTROL CHANNEL (PUCCH) RESOURCE DETERMINATION FOR REL. 16 TYPE II CHANNEL STATE INFORMATION (CSI)

(71) Applicants: NTT DOCOMO, INC., Tokyo (JP); DOCOMO INNOVATIONS,, Palo Alto, CA (US)

(72) Inventors: Nadisanka Rupasinghe, Chiyoda-ku, Tokyo (JP); Shohei Yoshioka, Chiyoda-ku, Tokyo (JP); Yuki Matsumura, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 17/597,975

(22) PCT Filed: Aug. 12, 2020
(86) PCT No.: PCT/US2020/045932

§ 371 Date: Jan. 31, 2022

Related U.S. Application Data
(60) Provisional application No. 62/885,582, filed on Aug. 12, 2019.

(51) Int. Cl. H04W 72/12; H04B 7/06; H04L 5/00

(52) U.S. Cl. CPC H04W 72/1231; H04B 7/063; H04L 5/0055; H04B 7/0626

(57) ABSTRACT

A user equipment (UE) in communication with a base station (BS) is disclosed that includes a processor that determines a Physical Uplink Control Channel (PUCCH) resource used for transmitting uplink control information (UCI) and a transmitter that transmits, to the BS, the UCI on the determined PUCCH resource. In other aspects a method performed by a UE and a wireless communication system are also disclosed.

### TECHNICAL FIELD

One or more embodiments disclosed herein relate to a method of determining Physical Uplink Control Channel (PUCCH) resource for Rel. 16 Type II Channel State Information (CSI) in a wireless communication system.

### BACKGROUND ART

Type II CSI feedback in 5G (fifth generation) NR (New Radio) Release 15 (Rel. 15) supports only rank 1 and 2. Further, feedback overheads associated with Rel. 15 Type II CSI are identified to be high.

In view of the above, in Rel. 16, it is identified to propose overhead reduction schemes for Type II CSI feedback and higher rank extension of Type II CSI feedback.

For overhead reduction, it is required to consider frequency domain (FD) compression technologies.

For higher rank extension, it is required to extend Type II CSI to rank 3 and rank 4, in addition to rank 1 and rank 2.

These new additions to Type II CSI in Rel. 16 necessitate revising existing CSI omission procedure to fit CSI in to allocated Physical Uplink Control Channel (PUCCH) and Physical Uplink Shared Channel (PUSCH) resources.

However, how to determine the PUCCH resource used for transmitting the CSI report for Type II CSI in Rel. 16 has not been determined.

### CITATION LIST

### Non-Patent Reference

[Non-Patent Reference 1] 3GPP TS 38.214 V15.3.0

### SUMMARY OF INVENTION

In one or more embodiments, the present invention relates to a user equipment (UE) in communication with a base station (BS), the UE comprising: a processor that determines a Physical Uplink Control Channel (PUCCH) resource used for transmitting uplink control information (UCI); and a transmitter that transmits, to the BS, the UCI on the determined PUCCH resource.

In one or more embodiments, the present invention relates to a method performed by a user equipment (UE) in communication with a base station (BS), the method comprising: determining a Physical Uplink Control Channel (PUCCH) resource used for transmitting uplink control information (UCI); and transmitting, to the BS, the UCI on the determined PUCCH resource.

In one or more embodiments, the present invention relates to a wireless communication system, comprising: a base station (BS); and a user equipment UE, comprising: a processor that determines a Physical Uplink Control Channel (PUCCH) resource used for transmitting uplink control information (UCI); and a transmitter that transmits, to the BS, the UCI on the determined PUCCH resource.

Other embodiments and advantages of the present invention will be recognized from the description and figures.

### BRIEF DESCRIPTION OF DRAWINGS

FIG. 1 shows a configuration of a wireless communication system according to one or more embodiments of the present invention.

FIG. 2 is an example of x-bit(s) DCI field(s) (reusing existing field(s) or using new field(s)) according to one or more embodiments.

FIG. 3 is a flowchart of a method of determining a PUCCH resource used for transmitting a CSI report according to one or more embodiments.

FIG. 4 shows an example of x-bit(s) DCI field(s) (reusing existing field(s) or using new field(s)) according to one or more embodiments.

FIG. 5 is a flowchart of a method of determining a PUCCH resource used for transmitting a CSI report according to one or more embodiments.

FIG. 6 shows an example of x-bit(s) DCI field(s) (reusing existing field(s) or using new field(s)) according to one or more embodiments.

FIG. 7 is a flowchart of a method of determining a PUCCH resource used for transmitting a CSI report according to one or more embodiments.

FIG. 8 shows a schematic configuration of a BS according to one or more embodiments.

FIG. 9 shows a schematic configuration of a UE according to one or more embodiments.

### DESCRIPTION OF EMBODIMENTS

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

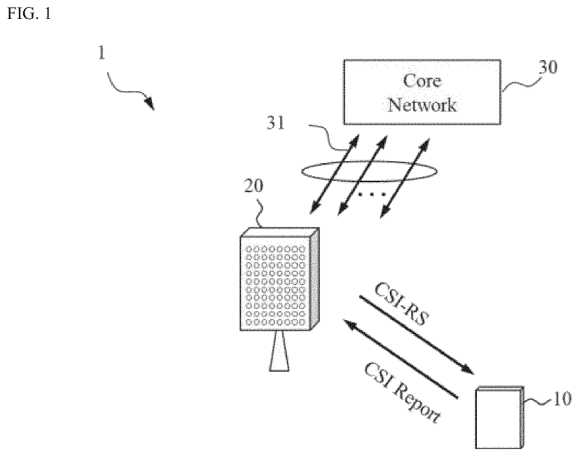

FIG. 1 is a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). In one or more embodiments, the BS 20 may be referred to as a network (NW).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 1, the BS 20 may transmit a CSI-Reference Signal (CSI-RS) to the UE 10. In response, the UE 10 may transmit a CSI report to the BS 20.

The wireless communication system 1 supports Type II CSI feedback. CSI to be reported for Type II CSI feedback may be referred to as Type II CSI. Type II CSI includes CSI Part 1 and CSI Part 2. CSI Part 1 has a fixed payload size and includes Rank Indicator (RI), Channel Quality Indicator (CQI), and an indication of the number of non-zero WB amplitude coefficients (NNZC) per layer for the Type II CSI. The fields of CSI Part 1 of the RI, the CQI, and the indication of the number of non-zero wideband amplitude coefficients for each layer may be separately encoded. CSI Part 2 includes Precoding Matrix Indicator (PMI) that includes WB PMI and SB PMI. In one or more embodiments, CSI Part 2 includes spatial domain (SD) and frequency domain (FD) basis indication, bit maps of each layer, strongest coefficient indicator of each layer, reference amplitude for the weaker polarization P_{ref} and LC coefficients. The size of bitmaps of each layer may be 2LM. “L” indicates a beam number. CSI Part 1 and CSI Part 2 may be separately encoded.

In one or more embodiments, information captured in CSI part 2 of Rel. 16 Type II CSI depends on both RI and NNZC.

The following information depends on RI (∈{1, 2, 3, 4}):

SD/FD basis indication;

Bitmaps indicating NZC of each layer (2LM bits required per layer);

Strongest coefficient indicator of each layer (log₂ 2L bits required per layer); and

Reference amplitude for the weaker polarization.

The following information depends on NNZC:

Non-zero coefficients: Phases and amplitudes (max. coefficients 2K₀ across all layers).

Thus, for determining PUCCH resources used for transmitting the CSI report, it is important to assume reasonable values for both RI and NNZC.

Methods of determining PUCCH resources used for transmitting the CSI report according to one or more embodiments will be explained below. In one or more embodiments, the CSI report is an example of uplink control information (UCI).

### FIRST EXAMPLE

According to one or more embodiments, if the UE 10 transmits a periodic CSI report or a semi-persistent CSI report that includes CSI Part 2, the UE 10 determines a PUCCH resource used for transmitting the CSI report and the number of PRBs in the PUCCH resource. In one or more embodiments, the periodic or semi-persistent CSI report may be a Rel. 16 Type II CSI report.

For example, for determination of the PUCCH resource and the number of PRBs, the UE 10 may assume that the periodic CSI report or semi-persistent CSI report indicates rank υ where υ can be 1, 2, 3 or 4. In other words, the NW may not indicate NNZC for PUCCH resource determination and the UE 10 may assume various values for rank and NNZC.

For example, for determination of the PUCCH resource and the number of PRBs, the UE 10 may assume that the periodic CSI report or semi-persistent CSI report or A-periodic CSI report indicates rank υ and NNZC=k. Possible values for υ may be 1, 2, 3 or 4 while k can be 2K₀ , K₀, ½K₀, ¼K₀, ⅛K₀ etc. In one or more embodiments, it may not be restricted to define any other NNZC value for PUCCH resource determination.

The above methods of UE assumption may be defined in the specification (e.g., 3GPP technical specification).

### SECOND EXAMPLE

According to one or more embodiments, the UE 10 assumes a set of NNZC values are defined in the specification which can be used for PUCCH resource determination

For example, the NW, which is referred to as the BS 20, informs the UE 10 which NNZC value to consider for PUCCH resource determination using Downlink Control Information (DCI) (e.g., activation DCI or activation Media Access Control Control Element (MAC CE) of semi-persistent (SP)-CSI) or higher layer signaling. This can be achieved as indicated by x-bit(s) DCI field(s) (reusing existing field(s) or using new field(s)) or MAC CE or using higher layer signaling, x is specified in the specification. For example, x is 2.

When the SP-CSI reporting is activated using the MAC CE, an additional parameter with x-bit(s) can be used to configure the NNZC value to be considered by the UE 10 when the UE 10 determines the PUCCH resources.

Further, the NNZC value to be considered by the UE 10 may be associated with the PUCCH resource. For example, the PUCCH resources with more PRBs (nrofPRBs) may be configured with the larger NNZC value. The NNZC value may be another configuration parameter in the PUCCH resource such as nrofPRBs, format.

As another example, the parameter of the NNZC value may be an optional parameter (in Radio Resource Control (RRC)) and,

1) only configured if type II CSI (Rel. 16) is configured;

2) only configured for
2-1) PUCCH format 2/3; or
2-2) PUCCH resource configured in PUCCH resource set; or

3) can be configured for any PUCCH resources.

If the parameter of the NNZC value is not configured in the PUCCH resource, the method of First Example may be performed.

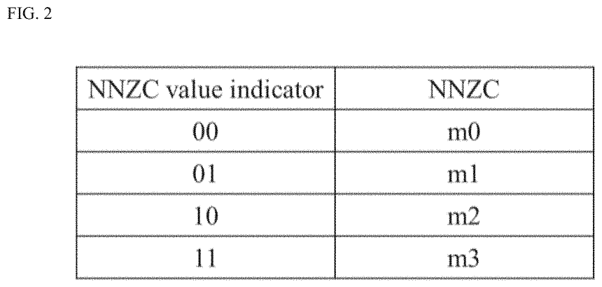

FIG. 2 is an example of x-bit(s) DCI field(s) (reusing existing field(s) or using new field(s)) according to one or more embodiments. In FIG. 2, the NNZC values of m0, m1, m2, and m3 correspond to the NNZC value indicators of “00,” “01,” “10,” and “11,” respectively. Further, the NNZC values of m0, m1, m2, and m3 may be specified in the specification, or RRC/MAC CE configured.

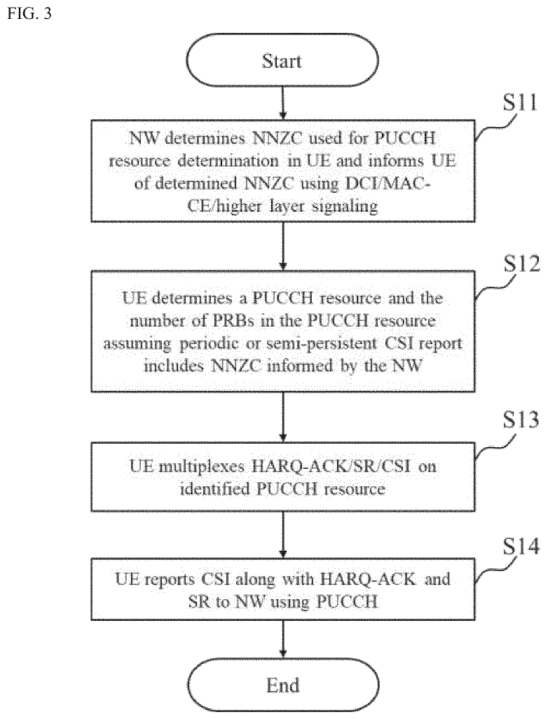

FIG. 3 is a flowchart of a method of determining a PUCCH resource used for transmitting a CSI report according to one or more embodiments.

As shown in FIG. 3, at step S11, the NW determines the NNZC value used for the PUCCH resource determination in the UE 10 and informs the UE 10 of the determined NNZC value using the DCI, the MAC-CE, or the higher layer signaling. If a set of possible NNZC values are defined in the specification, the NW may inform the UE 10 of which value to consider out of those using the DCI, the MAC-CE, or the higher layer signaling.

At step S12, the UE 10 determines the PUCCH resource and the number of PRBs in the PUCCH resource assuming the periodic or semi-persistent CSI report includes the NNZC value informed by the NW.

At step S13, the UE 10 multiplexes HARQ-ACK/Scheduling Request (SR)/CSI on the identified PUCCH resource.

At step S14, the UE 10 transmits the CSI report along with the HARQ-ACK and SR to the NW using the PUCCH.

### THIRD EXAMPLE

According to one or more embodiments, the UE 10 assumes that a set of possible ranks are defined in the specification, which can be used for the PUCCH resource determination

For example, the NW informs the UE 10 of which rank to be considered for the PUCCH resource determination using the DCI (e.g. activation DCI or activation MAC CE of SP-CSI) or higher layer signaling. This can be achieved as indicated by x-bit(s) DCI field(s) (reusing existing field(s) or using new field(s)) or MAC CE or using higher layer signaling, x is specified in the specification. For example, if the specification defines rank υ ∈ {1, 2, 3, 4}, using x=2 bits, the NW informs the UE of a rank used for the PUCCH resource determination.

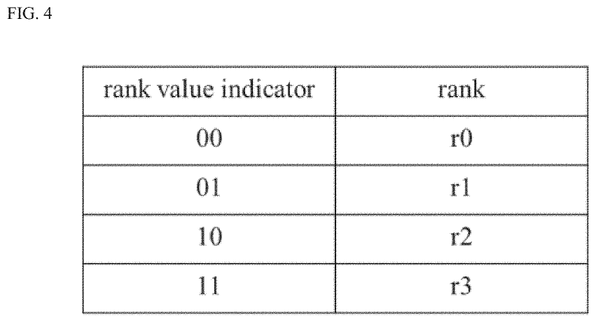

FIG. 4 shows an example of x-bit(s) DCI field(s) (reusing existing field(s) or using new field(s)) according to one or more embodiments. In FIG. 4, the rank values of r0, r1, r2, and r3 correspond to the rank value indicators of “00,” “01,” “10,” and “11,” respectively. The values of r0, r1, r2, and r3 may be specified in the specification (e.g., r0˜r3 is {1, 2, 3, 4}), or RRC/MAC CE configured.

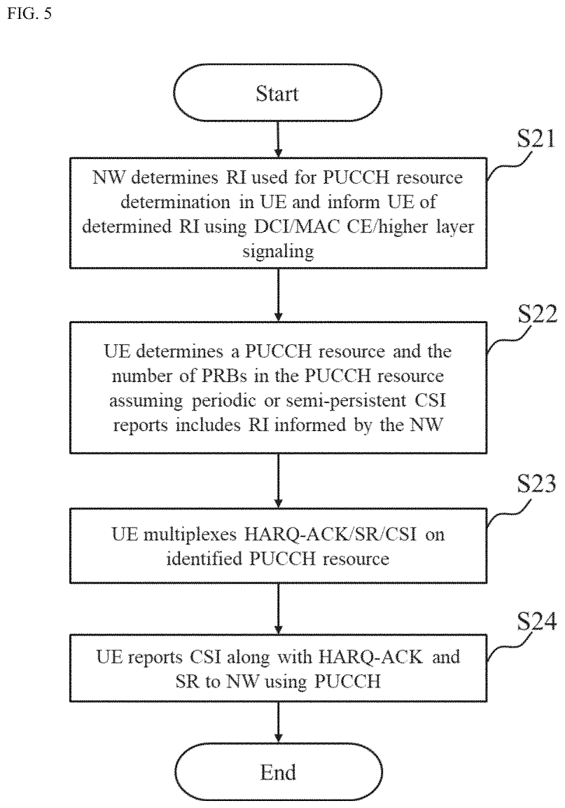

FIG. 5 shows a flowchart of a method of determining a PUCCH resource used for transmitting a CSI report according to one or more embodiments.

In FIG. 5, at step S21, the NW determines the RI used for the PUCCH resource determination in UE and inform UE of the determined RI using the DCI, MAC CE, or higher layer signaling. If a set of possible RI values are defined in the specification, the NW informs the UE of which value to consider out of those using the DCI, MAC CE, or higher layer signaling.

At step S22, the UE 10 determines the PUCCH resource and the number of PRBs in the PUCCH resource assuming the periodic or semi-persistent CSI report includes the RI informed by the NW.

At step S23, the UE 10 multiplexes HARQ-ACK/SR/CSI on the identified PUCCH resource.

At step S24, the UE 10 transmits the CSI report along with the HARQ-ACK and SR to the NW using the PUCCH.

### FOURTH EXAMPLE

According to one or more embodiments, the UE 10 assumes a set of possible (υ, k) pairs where υ is the rank value and k is the NNZC value, are defined in the specification which can be used for PUCCH resource determination

For example, the NW informs the UE of which pair is used for the PUCCH resource determination using the DCI (e.g. activation DCI or activation MAC CE of SP-CSI) or higher layer signaling. This can be achieved as indicated by x-bit(s) DCI field(s) (reusing existing field(s) or using new field(s)) or MAC CE or using higher layer signaling, x is specified in the specification. If the specification defines four such pairs, using x=2 bits, the NW informs the UE 10 of which pair is used for the PUCCH resource determination.

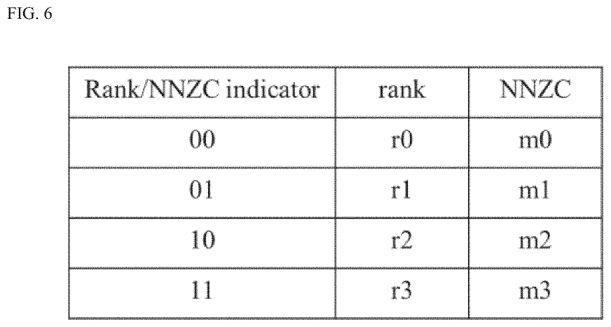

FIG. 6 shows an example of x-bit(s) DCI field(s) (reusing existing field(s) or using new field(s)).

As shown FIG. 6, the value of r0, r1, r2, and r3 and/or m0, m1, m2, and m3 are/is specified in the specification (e.g. r0˜r3 is {1, 2, 3, 4}), or RRC/MAC CE configured. In FIG. 6, the value of r0˜r3 and/or m0˜m3 are/is specified in the specification (e.g., r0˜r3 is {1, 2, 3, 4}), or RRC/MAC CE configured.

Rank assumption to determine the PUCCH resource is not limited to 1, if Rel. 16 type II CSI is higher layer configured and/or activated/indicated to report.

One or more embodiments discussed above are for Rel. 16 Type II CSI which may be identified as some other name as well, e.g. Type III CSI.

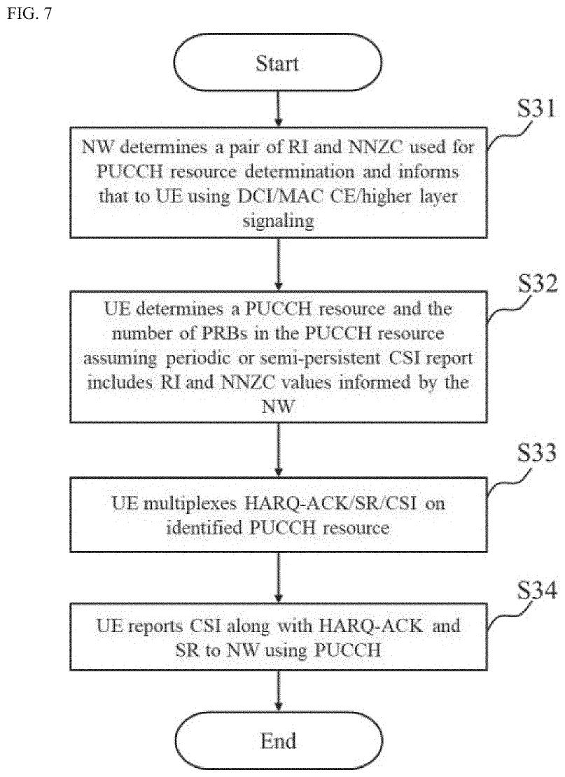

FIG. 7 shows a flowchart of a method of determining a PUCCH resource used for transmitting a CSI report according to one or more embodiments.

In FIG. 7, at step S31, the NW determines a pair of RI and NNZC used for PUCCH resource determination and informs that to UE using the DCI, MAC CE, or higher layer signaling.

At step S32, the UE 10 determines the PUCCH resource and the number of PRBs in the PUCCH resource assuming the periodic or semi-persistent CSI report includes the RI and NNZC values informed by the NW.

At step S33, the UE 10 multiplexes the HARQ-ACK/SR/CSI on the identified PUCCH resource.

At step S34, the UE lo reports the CSI along with HARQ-ACK and SR to the NW using the PUCCH.

### ANOTHER EXAMPLE

In one or more embodiments, the CSI introduced in Rel. 16 is not transmitted on the PUCCH. That is, if CSI reporting is configured/activated/triggered on the PUCCH, the NNZC is not included in the CSI report. Else if CSI reporting is configured/activated/triggered on the PUSCH, the NNZC is included in the CSI report.

In one or more embodiments, the RI and NNZC values assumed by the BS 20 and the UE 10 to determine the PUCCH resource may be different depending on whether the CSI report is transmitted on the configured/activated/triggered PUCCH or not. For example, if the PUCCH containing the CSI report (defined as PUCCH-B) is overlapped with other PUCCH(s) and/or if the PUCCH containing the CSI report is overlapped with PUSCH(s), and the CSI report is transmitted on a PUCCH resource different from PUCCH-B or a PUSCH, RI=4 and NNZC=2K₀. Else if the CSI report is transmitted on PUCCH-B, RI=1 and NNZC=K₀. To avoid configuring the CSI with excessive amount of the PUCCH resource, and to enable to report all CSI reports sometimes.

The above values of RI and NNZC are example values to be considered.

### Configuration of Base Station

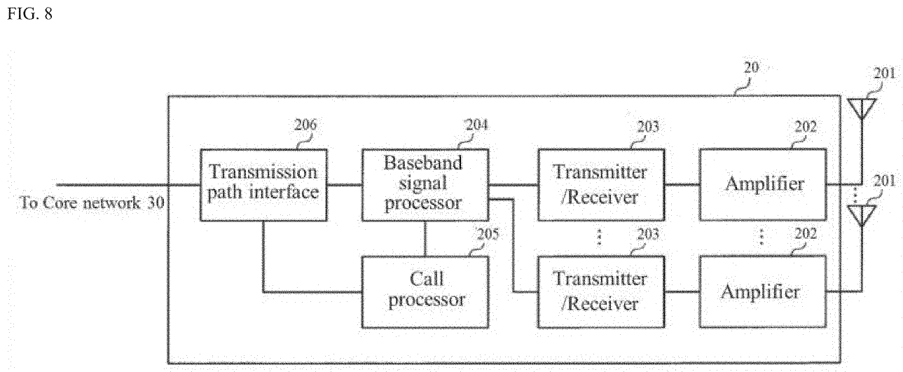

The BS 20 according to one or more embodiments of the present invention will be described below with reference to FIG. 8. FIG. 8 is a diagram illustrating a schematic configuration of the BS 20 according to one or more embodiments of the present invention. The BS 20 may include a plurality of antennas 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antenna 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

### Configuration of User Equipment

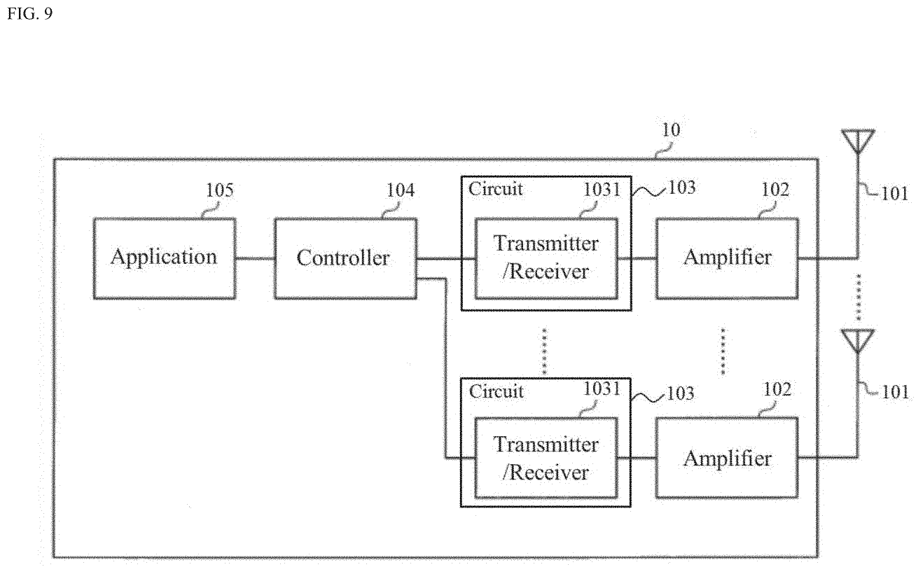

The UE 10 according to one or more embodiments of the present invention will be described below with reference to FIG. 9. FIG. 9 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments may exhibit one or more of the following advantages. In one or more embodiments, overhead may be reduced in CSI feedback schemes. In particular, in one or more embodiments, Type II CSI feedback overheard may be reduced. Further, one or more embodiments may advantageously facilitate that a CSI payload may fit into allocated PUSCH resource(s) and code rate(s).

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A user equipment (UE) in communication with a base station (BS), the UE comprising:
a receiver that receives, from the BS via higher layer signaling, an indicator used for Physical Uplink Control Channel (PUCCH) determination;
a processor that determines a PUCCH resource and a number of Physical Resource Blocks (PRBs) in the PUCCH resource based on the indicator, and multiplexes a Hybrid Automatic Repeat Request-Acknowledgement (HARQ-ACK), a Scheduling Request (SR), and a Channel State Information (CSI) on the PUCCH resource; and
a transmitter that transmits, to the BS, a CSI report along with the HARQ-ACK and the SR using the PUCCH resource.

2. (canceled)

3. The UE according to claim 1, wherein the indicator is a rank value.

4. The UE according to claim 3, wherein the rank value is 1, 2, 3, or 4.

5. (canceled)

6. The UE according to claim 3, wherein the rank value is pre-configured in the UE.

7. (canceled)

8. The UE according to claim 1, wherein the indicator is a number of non-zero coefficient (NNZC) values.

9. The UE according to claim 8, wherein the NNZC value is pre-configured in the UE.

10. The UE according to claim 1, wherein when the indicator is a plurality of NNZC values, a set of the plurality of NNZC values is pre-configured in the UE.

11. The UE according to claim 1, wherein the indicator is a pair of a rank value and a number of non-zero coefficients (NNZC) value.

12. The UE according to claim 11, wherein the rank value and the NNZC value are pre-configured in the UE.

13. The UE according to claim 1, wherein when the indicator is a plurality of pairs of a rank value and a NNZC value, a set of the plurality of pairs is pre-configured in the UE.

14. A method performed by a user equipment (UE) in communication with a base station (BS), the method comprising:
receiving, from the BS via higher layer signaling, an indicator used for Physical Uplink Control Channel (PUCCH) determination;
determining a PUCCH resource and a number of Physical Resource Blocks (PRBs) in the PUCCH resource based on the indicator;
multiplexing a Hybrid Automatic Repeat Request-Acknowledgement (HARQ-ACK), a Scheduling Request (SR), and a Channel State Information (CSI) on the PUCCH resource; and
transmitting, to the BS, a CSI report along with the HARQ-ACK and the SR using the PUCCH resource.

15. (canceled)

16. The method according to claim 14, wherein the indicator is a rank value.

17. The method according to claim 16, wherein the rank value is 1, 2, 3, or 4.

18. (canceled)

19. The method according to claim 16, wherein the rank value is pre-configured in the UE.

20. The method according to claim 14, wherein when the indicator is a plurality of rank values, a set of the plurality of rank values is pre-configured in the UE.

21. The method according to claim 14, wherein the indicator is a number of non-zero coefficient (NNZC) values.

22. The method according to claim 21, wherein the NNZC value is pre-configured in the UE.

23. (canceled)

24. The method according to claim 14, wherein the indicator is a pair of a rank value and a number of non-zero coefficients (NNZC) value.

25. A wireless communication system comprising a base station (BS) and a user equipment (UE), wherein:
the BS comprises:
a processor that determines an indicator used for Physical Uplink Control Channel (PUCCH) determination; and
a transmitter of the BS that transmits the indicator; and
the UE comprises:
a receiver that receives, from the BS via higher layer signaling, the indicator;
a processor that determines a PUCCH resource and a number of Physical Resource Blocks (PRBs) in the PUCCH resource based on the indicator, and multiplexes a Hybrid Automatic Repeat Request-Acknowledgement (HARQ-ACK), a Scheduling Request (SR), and a Channel State Information (CSI) on the PUCCH resource; and
a transmitter of the UE that transmits, to the BS, a CSI report along with the HARQ-ACK and the SR using the PUCCH resource.

26. The UE according to claim 1, wherein when the indicator is a plurality of rank values, a set of the plurality of rank values is pre-configured in the UE.
